(19) United States
(12) Patent Application Publication
(10) Pub. No.: US 2016/0052814 A1
(43) Pub. Date: Feb. 25, 2016

(54) SYSTEM AND METHOD FOR FLUID AND SOLID WASTE TREATMENT

(71) Applicant: LNV FRAC WATER RECYCLING, LLC, Corpus Christi, TX (US)

(72) Inventors: Dan S. Leyendecker, Corpus Christi, TX (US); Robert M. Viera, Corpus Christi, TX (US); Derek E. Naiser, Boerne, TX (US); Marcus Naiser, Austin, TX (US); Logan Burton, Rockport, TX (US); Richard Saenz, Corpus Christi, TX (US); Ryan Scott Mersmann, Magnolia, TX (US); Guadalupe Lorenzo Rocha, Corpus Christi, TX (US)

(21) Appl. No.: 14/831,796

(22) Filed: Aug. 20, 2015

Related U.S. Application Data
(60) Provisional application No. 62/040,313, filed on Aug. 21, 2014.
(60) Provisional application No. 62/120,528, filed on Feb. 25, 2015.

(51) Int. Cl. C02F 9/00; C09K 8/58

(52) U.S. Cl. CPC C02F 9/00; C09K 8/58; C02F 2103/10

(57) ABSTRACT

Embodiments of scalable systems and methods for treating and/or processing a variety of waste streams from any oil or gas exploration and/or production activity, including both fluid and solid wastes. In one embodiment, a water treatment facility and/or system comprises one or more input stations for receiving solid wastes and/or fluid wastes, one or more oil and water separation systems for separating oil and hydrocarbons from the fluid, and a plurality of water treatment processes and/or systems to remove solids from the fluid. In other embodiments, a solids treatment system is disclosed that can process solid wastes from any oil or gas exploration and/or production activity as well as the water treatment facility. The treated water and solids can be used for beneficial re-use applications (both off-site and on-site) without any deep well injection.

### PRIORITY

This application claims priority to and the benefit of U.S. provisional patent application No. 62/040,313, filed on Aug. 21, 2014, and U.S. provisional patent application No. 62/120,528, filed on Feb. 25, 2015. The entire content of these provisional applications is incorporated herein by reference.

### FIELD

This disclosure relates to the treatment of water and wastewater, and more particularly to the treatment of a wide variety of oil and gas fluid and solid waste streams for beneficial reuse.

### BACKGROUND

Water is a vital resource for numerous applications, including consumption, industrial, and agricultural purposes (including others). Each year, billions of gallons of water are used by the oil and gas industry in a technique called hydraulic fracturing, which combines chemical additives, proppants (sand), and other solid materials in a water based mixture known as hydraulic fracturing fluid that is pumped at high pressures into the well bore. As this water is pumped into the ground to begin the hydraulic fracturing process, the water begins to mix with salts, oil, grease, organic materials, and metals that prevent the fluid from any re-use applications (unless otherwise treated). Such fluid is typically disposed of via deep injection wells.

In general, two types of wastewater streams are obtained as a result of the injected hydraulic fracturing fluid: produced and flowback water. “Produced water” is wastewater that is returned to the surface and separated from the product of an oil or gas well during production throughout the lifespan of the well. Chemical additives and concentrations will typically be more dilute in produced water as a significant amount of natural formation water is produced from the drilling process, mixing with the injected hydraulic fracturing fluid. “Flowback water” is wastewater recovered anywhere from a few hours to a few weeks after a frac job. This water directly results from the high-pressure flow of hydraulic fracturing fluid that occurs during operation. Compared to produced water, flowback water will typically contain much higher levels of inorganic and organic constituents such as dissolved salts and naturally occurring radioactive material (NORM) as well as high levels of chemical additives. As both produced and flowback water may be collected individually yet treated using the same treatment processes and separation methods, this disclosure and the described design process will generically refer to the different wastewater streams collectively as used water and/or wastewater. Besides many other contaminants, the used fluid will contain unacceptable (and problematic) amounts of total suspended solids (TSS), scale-forming ions, and total dissolved solids (TDS).

Ultimately, the hydraulic fracture process is a very expensive operation, not only due to the purchase of equipment, but also due to the purchase, acquirement, and transportation of hundreds of millions of gallons of water required for frac operations. Conventional processes exist, in general, to treat the hydraulic fracturing fluid, such as various separation processes that remove the contaminants from the water to avoid (or minimize) disposal or injection well plugging or other pumping of underground aquifers. Besides hydraulic fluids, numerous other fluid wastes are produced from oil and gas exploration and production activities. Existing fluid treatment techniques are ineffective and present many disadvantages, such as large capital and operating costs, long installation time, and low operating efficiencies. Further, conventional water treatment techniques are not well equipped to handle and process solids wastes from oil and gas operations.

A need exists for an improved method and system for water recycling and waste treatment of wastewater and other fluids, particularly one that eliminates the need for deep well injection of waste and/or treated fluids. A need exists for a system that provides beneficial re-use for such waste fluids, as well as related solids from an oil and gas operation. A need exists for a comprehensive, cost-effective solution to provide treatment and beneficial re-use for the oil and gas industry's fluid wastes and solid wastes.

### SUMMARY

Embodiments of systems and methods for treating and/or processing a variety of waste streams from any oil or gas exploration and/or production activity, including both fluid and solid wastes. In one embodiment, a facility and/or system comprises one or more input stations for receiving solid wastes and/or fluid wastes, one or more oil and water separation systems for separating oil and hydrocarbons from the fluid, and a plurality of water treatment processes and/or systems to remove solids from the fluid. Additional embodiments may comprise reverse osmosis filters, clarification devices, desanding units, dewatering systems, and filter presses to provide enhanced water purification and/or solids removal.

In other embodiments, a solids treatment system is disclosed that can process solid wastes from any oil or gas exploration and/or production activity as well as the disclosed waste treatment facility. The solids treatment system may comprise one or more input stations for receiving solid wastes, a plurality of solids treatment cells configured to treat the wastes, a plurality of solids storage cells to store the treated waste for beneficial re-use applications, and a plurality of land treatment areas in which the treated solid waste (or portions thereof) may be incorporated into one or more areas of land.

In one embodiment, the treated water and solids can be used for beneficial re-use applications. For example, the remediated water can be used as fracturing fluid, irrigation water, and/or cementing operations, and the remediated solids can be used as clean fill material, road base material, and various land applications.

In one embodiment, the water treatment process includes receiving one or more used fluids at an input station, recovering oil from the fluid, treating the fluid with a plurality of water-treatment steps to remove a plurality of solids and/or contaminants substantially from the fluid, and recovering the treated fluid for beneficial re-use. In one embodiment, the solids treatment process includes treating a plurality of solids for beneficial re-use by separating the solids into a plurality of solids treatment cells, treating the solids in each of the solids treatment cells, and recovering the solids in each of the solids treatment cells.

The foregoing summary is intended to introduce a subset of the various aspects of the embodiments of the present disclosure and should not be considered limiting.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows one schematic of an embodiment of a water treatment system for any wastewater from an oil and gas operation.

FIG. 2A shows one schematic of an input system of the disclosed water treatment system.

FIG. 2B shows one schematic of an embodiment of an oil and water separation system of the disclosed water treatment system.

FIG. 3 shows one schematic of an embodiment of a water pre-treatment system of the disclosed water treatment system.

FIG. 4 shows one schematic of another embodiment of a water treatment system for any wastewater from an oil and gas operation.

FIG. 5 shows one schematic of an embodiment of a water treatment system and a solids treatment system for any wastes from an oil and gas operation.

FIG. 6 shows one schematic of an embodiment of a reverse osmosis system of the disclosed water treatment system.

FIG. 7 shows one schematic of an embodiment of a water treatment facility.

FIG. 8 illustrates one embodiment for a water treatment process to treat waste fluids from oil and gas operations.

FIG. 9 illustrates one embodiment for a solids treatment process to treat solids from oil and gas operations or the disclosed water treatment facility.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure. The following detailed description does not limit the invention.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. The various embodiments are not necessarily mutually exclusive, as some embodiments can be combined with one or more other embodiments to form new embodiments. Likewise, particular features, structures, or characteristics of one embodiment may be combined in any suitable manner with particular features, structures, or characteristics of another embodiment. Wherever possible, the same reference numbers will be used throughout the drawings to refer to the same or like parts.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

### Overview

The disclosed embodiment provides a novel solution to one or more of the industry's needs previously described herein and offers superior advantages over conventional waste treatment solutions. The improved system described in this application solves many of the oil and gas industry's waste (both solids and fluids) treatment problems and allows any oil and gas waste fluid transported to the disclosed facility to be received, treated, stored, and recycled for beneficial re-use. Additionally, the disclosed system eliminates the need to dispose of waste fluids and solids in deep injection wells and is intended to reduce the amount of water consumption used in oil and gas operations. Thus, the disclosed system allows for a reduced cost of water required for drilling operations by minimizing and/or eliminating the quantity and toxicity of oil and gas wastes that would require disposal. The disclosed embodiments include systems, methods, and apparatuses for a reduction of the overall water consumption necessary for oil and gas exploration and production activities by treating and recycling the produced and flowback water and other waste streams produced from an oil and gas operation for beneficial re-use. The disclosed system is configured to process both waste fluids and solids from any oil and gas facility and treat such products for beneficial re-use. The disclosed system utilizes off the shelf components and/or systems that are easily manufactured in a novel way to produce a comprehensive waste management system that provides an efficient way to process fluid and solid wastes at a single location.

While one embodiment of the disclosed system is configured to treat hydraulic fracturing fluids, one of ordinary skill will recognize that the described embodiments may be used in any fluid waste stream from an oil and gas production and/or exploration activity, including but not limited to at least the following: hydraulic fracturing flowback; completion, workover, and stimulation fluids; saltwater (produced brine and produced water); produced formation fresh water; pipeline hydrostatic test water; storm water from containment and pits; washout pit water and solids; produced formation sand and other solids from saltwater storage tanks/vessels/pits; contaminated soil from spills of crude oil, condensate, and saltwater; production tank bottoms; non-hazardous solids from natural gas plant processing and other production facilities; clay liners from reserve and washout pits; water-based drilling fluids and cuttings; and oil-based drilling fluids and cuttings. Still further, the invention is not limited to merely fluids from oil and gas production facilities, but can be applied to other wastewater streams as well, such as groundwater or wastewaters from oil refineries. Any one or more of these waste fluids streams may generally be classified as a wastewater fluid.

In one embodiment the disclosed treating and recycling system can be used to treat any wastewater fluid to produce completion fluids (such as heavy H₂0), fluids used in cementing operations, and fluids that may be introduced to the environment via irrigation application. Likewise, while the disclosed embodiment requires the transport of hydraulic fracturing fluid to a remote facility, the disclosed components may be incorporated into a mobile facility that can be transported to a variety of locations or a facility at the location of the well site.

In one embodiment, a remote treatment facility is configured as a one-stop treatment plant to reduce the net water consumption in oil and gas wells, whether by horizontal drilling or conventionally drilled wells. In one embodiment, the facility is configured for offloading of wastewater fluids, washing of haul tanks, and treating and/or recycling wastewater fluids to be re-used for frac operations, completion fluids, cementing operations, or irrigation applications. During the offloading phase, trucks may provide recovered wastewater fluid straight from the field. In one embodiment, water separation and treatment techniques are used to produce fluids acceptable for reuse as hydraulic fracturing fluids. In other embodiments, the disclosed process may output clean water to be used for cementing purposes or irrigation applications and a brine water solution that can be used for well completion operations. In other embodiments, an oil recovery stage can separate and/or collect oil from the wastewater fluid (found in hydraulic fracturing fluids and other wastewater fluids) that can be sold, which prevents the re-injection of oil back into formations in the ground. In still other embodiments, a solids dewatering process is incorporated that is configured to remove and collect dewatered solids for disposal or re-use (such as for land fill, road base, or other land application), which may be transported to and treated in a solids treatment facility.

The disclosed embodiment offers many advantages over existing water treatment techniques. For example, existing and future restrictions of water handling (such as transportation, disposal, or discharge) can easily be handled due to the water separation and filtration techniques utilized. Further, the disclosed water treatment and solids treatment systems may be configured to recycle its own water, thereby allowing for water to oil and gas ratios to increase with time from the disclosed recycling process, as well as allow the operator to save money on disposal, trucking, and water procurement costs. Still further, one embodiment of the disclosed process is configured to treat any solid wastes produced from an oil and gas facility for beneficial re-use, including clean fill material, road base material, and land applications. The disclosed process offers a comprehensive solution to the oil and gas industry's waste issues and provides a much more efficient and cost-effective manner to treat wastewater and solids than conventionally available. The disclosed system is scalable, and can easily be adjusted to increase or decrease the amount of fluid and solid wastes that the facility can receive, treat, and recycle. In one embodiment the waste treatment system is configured to receive and treat approximately 6,000 barrels or more of waste fluid per day and the solids treatment system is configured to receive and treat approximately 200,000 or more of cubic yards of solid waste per year.

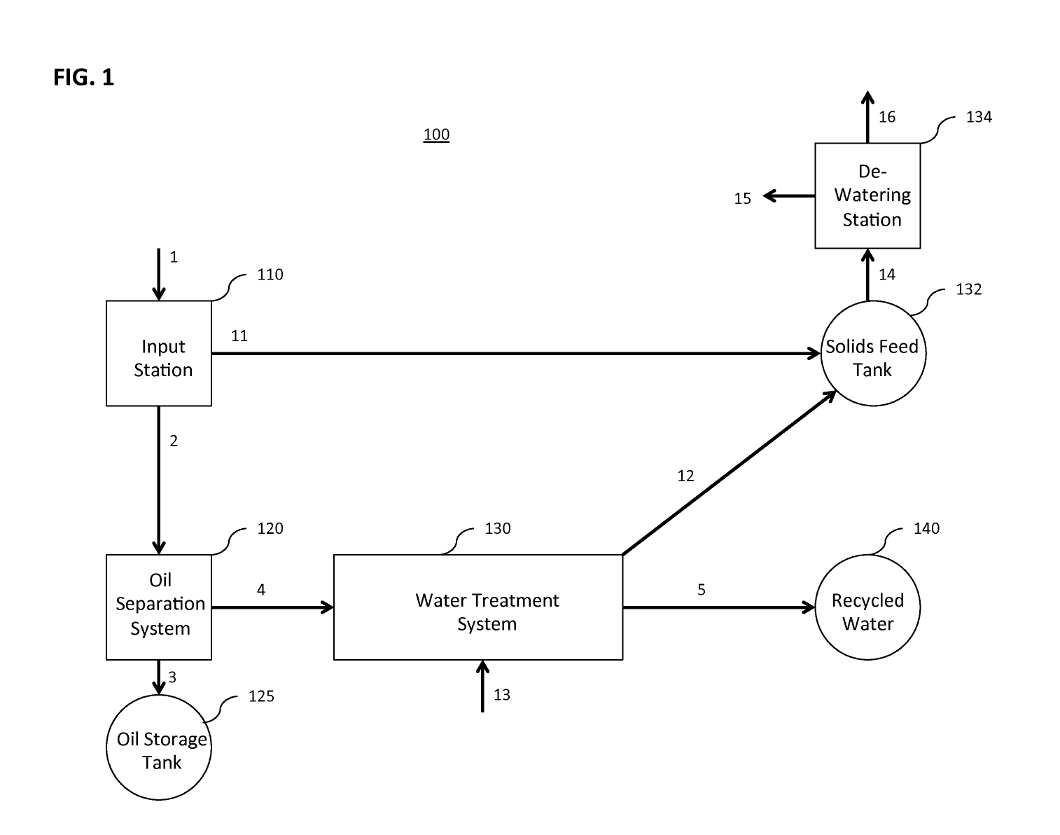

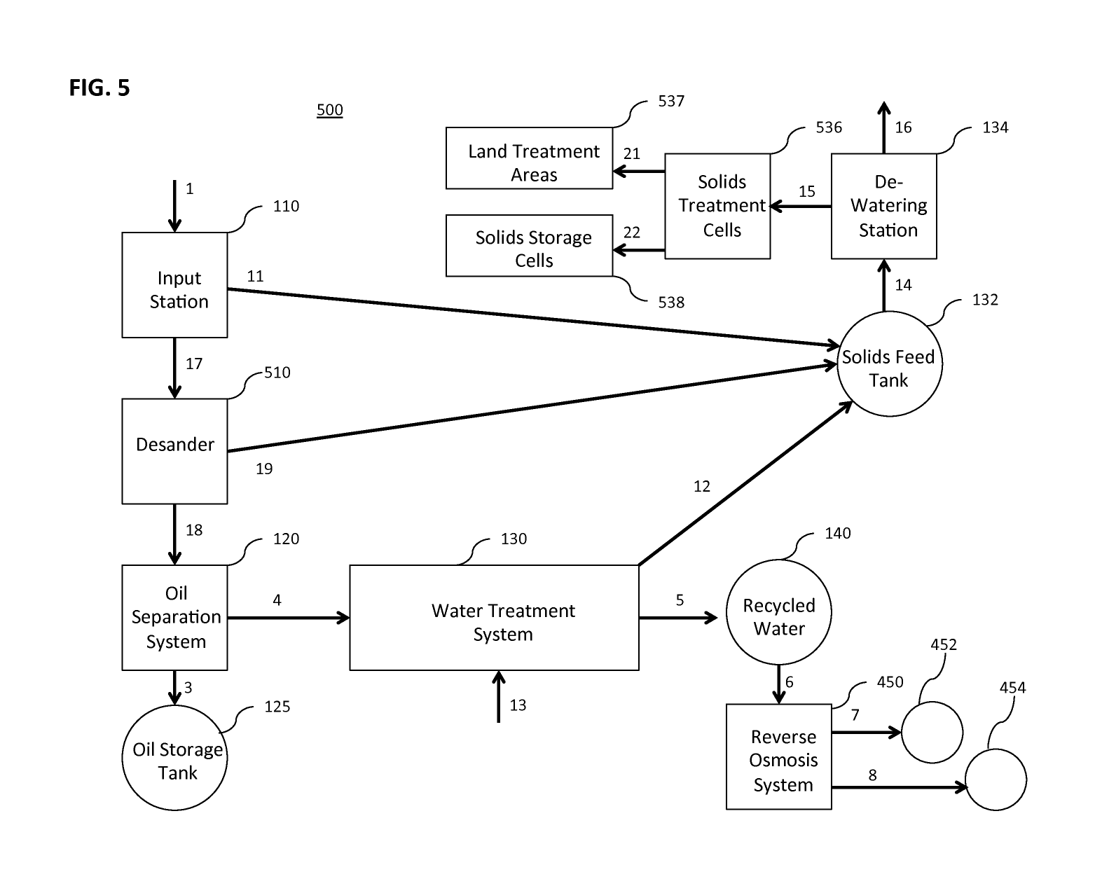

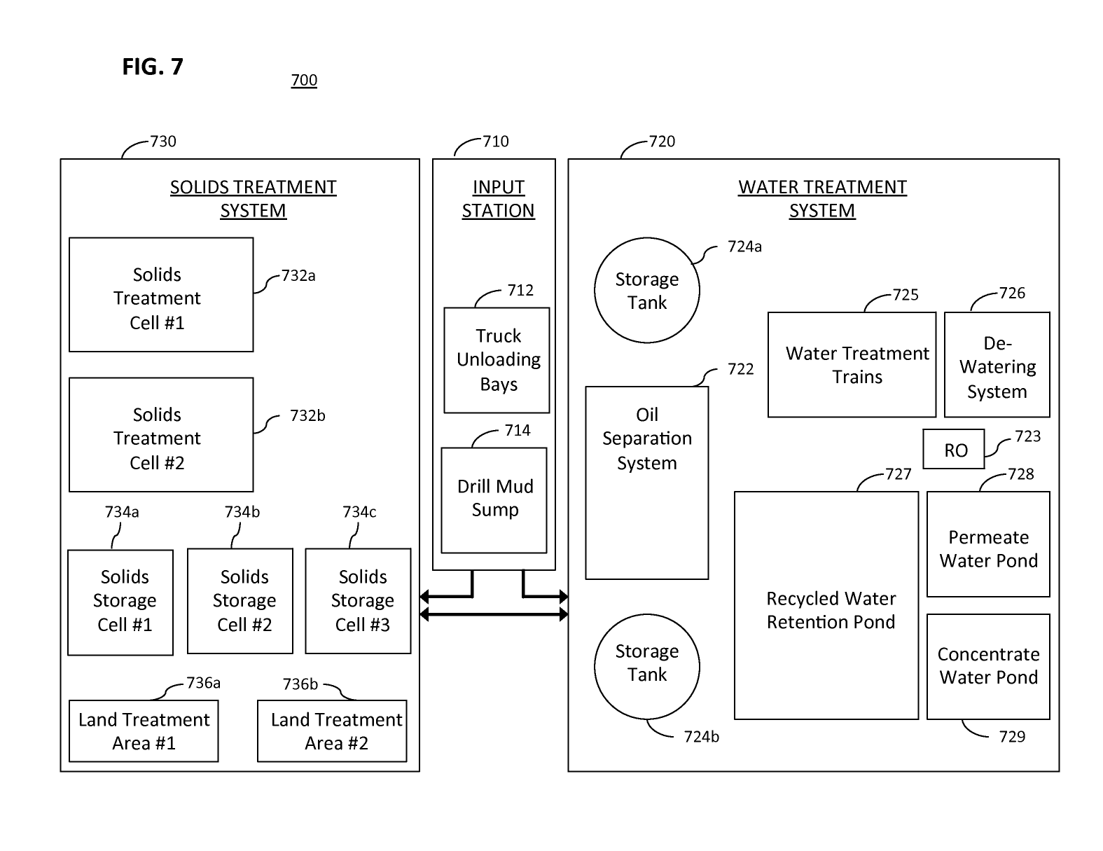

In general, as shown in FIG. 1, the disclosed embodiment comprises a water treatment facility that comprises three major processes to treat the incoming fluid wastes and includes the following: an input stage 110, an oil and water separation stage 120, and a water treatment stage 130. One or more of these stages may comprise various stages, systems, or sub-processes. As discussed in more detail in relation to FIGS. 5 and 7, the water treatment facility may be coupled to a solids treatment facility that is configured to treat a wide variety of solid wastes from any oil and gas production or exploration activity and/or the water treatment facility disclosed in FIG. 1.

### Step I—Input

As shown in FIG. 1, water treatment system 100 comprises a facility with input station 110. Because the facility may be remote from the source of wastewater, the wastewater to be treated needs to be transported to the treatment facility. In one embodiment, trucks and/or containers are used to transport used hydraulic fluids and other wastewater fluids to the facility. Input station 110 is configured to receive such trucks and/or containers and may comprise one or more sumps (holding ponds) or receiving tanks or containers. Input station 110 may be configured with a plurality of truck unloading sumps and truck wash out stations. The incoming trucks may contain drilling mud and/or drilling fluids that can be emptied into a sump for processing. In one embodiment, the unloaded trucks may be washed of all fluids and rinsed out with clean water at one or more truck wash stations, which will reduce the down time of each truck. In other embodiments, the incoming trucks can be used as outgoing trucks to transport the treated water from the disclosed treatment facility. In other embodiments, particularly when the treatment facility is located at or near the well site and/or source of wastewater (e.g., a local facility), a series of pipes and pumps can be used (instead of or in conjunction with trucks) that transport the to-be-treated wastewater fluid to input station 110.

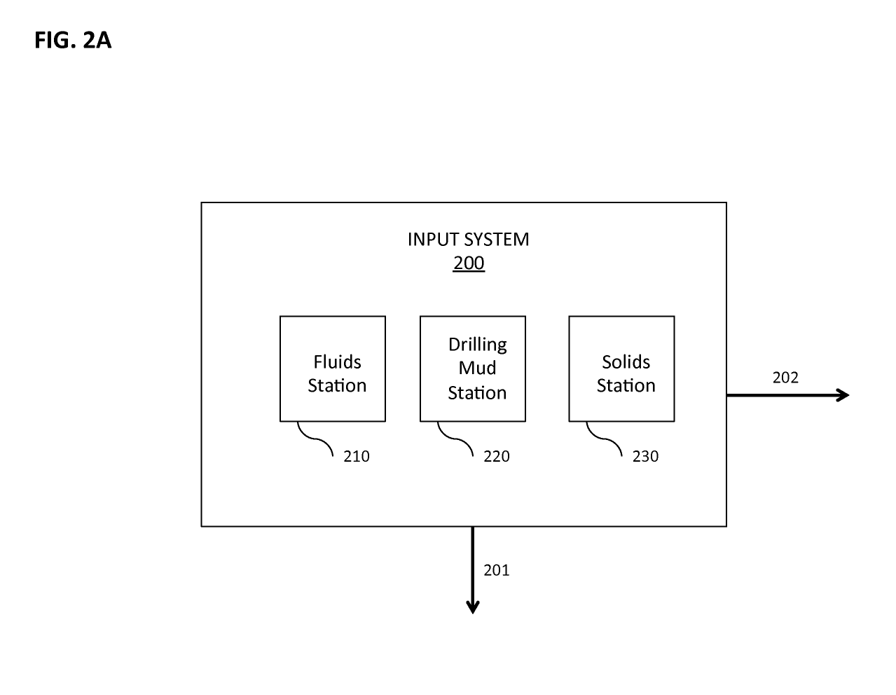

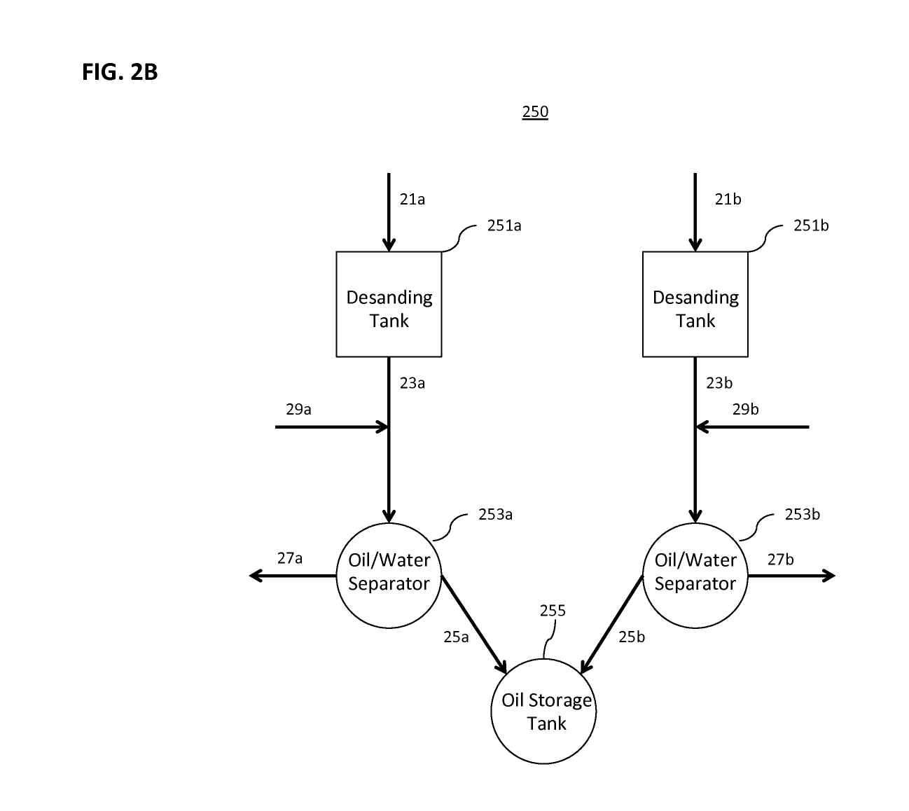

In one embodiment, input station 110 may comprise a plurality of receiving stations and/or sumps to receive different types of wastewater fluids. In one embodiment input station 110 comprises two sumps, a drilling mud sump and a wastewater/frac fluid sump. This allows an operator to route and/or treat the drilling mud fluids separate from the rest of the wastewater fluids. In another embodiment, truck unloading stations and a sump may be used together for hydraulic fracturing fluids and drilling muds, respectively. In still another embodiment, trucks may unload directly to a solids treatment station/cell and bypass the water treatment system. As shown in FIG. 2A, input system 200 (which may be substantially similar to input station 110) may comprise a plurality of unloading stations, pits, or sumps consisting of fluids station 210, drilling mud station 220, and solids station 230. Ultimately, solids recovered from any one of these input stations may be sent via line 202 for a dewatering phase and/or land re-use applications. Fluids recovered from input system 200 will continue the treatment and separation process via stream 201 to the oil/water separation system (such as oil separation system 120). Other pits, sumps, or containers may be appropriate based on the type (and volume) of incoming fluid or solid. Incoming trucks may offload and/or transport a fluid to the most appropriate sump.

Referring back to FIG. 1, each sump of input station 110 may be coupled to a solids removal process/system to remove a portion of any solids in the fluid via stream 11. For example, a shale shaker or screen over the drill mud sump may be configured to separate larger solids and/or debris, such as undesired waste and cuttings from the drill mud stream. Gravity settling may also be implemented in order to remove smaller solid particles. One embodiment may use the sump as a pre-treatment vessel allowing for chemical treatment additives before the wastewater is sent to oil and water separation system 120. In one embodiment each sump of input station 110 may be configured to output two fluid streams, consisting of either a solids stream 11 or a water and hydrocarbons stream 2. For example, once gravity settling has occurred in the drill mud sump, water and hydrocarbons can be decanted from the top layer of the sump and sent via line 2 to the next step in the treatment and separation process (e.g., oil/water separation system 120) while the settled solids and drill mud that have accumulated in the bottom of the sump can be sent to a solids feed tank 132 via line 11 before dewatering.

### Step II—Oil & Water Separation

As shown in FIG. 1, once the wastewater fluid has passed through input station 110 (which may be a plurality of truck unloading stations), a fluid containing substantially water and hydrocarbons is sent via stream 2 to oil separation system 120. The solids unloaded into their respective sumps or tanks during the unloading phase (or otherwise removed from the fluids during input station 110) are sent via line 11 to solids feed tank 132 before dewatering and beneficial re-use of the collected solids. As described above, while the contents of a drill mud sump will consist mostly of drilling mud and a frac fluid sump will consist mostly of fracturing fluid (e.g., the fluids will mostly or substantially consist of water), the fluids will also contain hydrocarbons (e.g., oil). In one embodiment, approximately 0.5-1% of fluid stream 2 consists of oil. The oil present in stream 2 can be separated and/or recovered in the oil and water separation stage 120 and output via stream 3 into one or more oil storage tanks 125.

In one embodiment oil and water system 120 includes at least one oil and water separation unit or skim tank, such as that disclosed in U.S. Pat. No. 8,496,740, incorporated herein by reference. In another embodiment, oil and water system 120 may comprise one or more gun barrels. In still other embodiments, as shown in more detail in FIG. 2B, oil and water separation system 250 (which may be substantially similar to oil and water system 120) comprises a plurality of de-sanding tanks 251a, 251b and a plurality of oil/water separators 253a, 253b (one for each hydrocarbon/water stream from the sumps or unloading bays) and one oil storage tank 255, which will collect the oil streams 25a, 25b from each oil/water separator.

As shown in FIG. 2B, hydrocarbon/water streams 21a, 21b from a sump or unloading station of input station 110 are first routed to de-sanding tanks 251a, 251b. These de-sanding tanks allow for an initial solid particle separation from the incoming fluid in order to prevent solids build up in oil/water separators 253a, 253b downstream of the de-sanding tanks, which in part works based upon a reduction of velocity of the incoming fluid streams by a variety of non-moving parts. Furthermore, the downtime of the facility is reduced as solids build up will accumulate primarily in the de-sanding tanks rather than the oil/water separators, which reduces the maintenance, cleaning, and shutdown time required for the disclosed system. Before settling in oil/water separators 253a, 253b, the fluid streams 23a, 23b may be injected with an emulsion breaker and/or a paraffin solvent via streams 29a, 29b and passed through an inline static mixer (not shown). Additionally, an oxidation agent may be injected for iron reduction in the fluid and to closely monitor and limit levels of hydrogen sulfide, iron sulfide, and microbes/bacteria in the fluid. These chemical injections facilitate the separation of oil from water and help prevent or decrease paraffin buildup in the flow line. Paraffin buildup may reduce and even prevent fluid flow in some situations, so it is advantageous to remove paraffin early in the treatment process. In some embodiments, a plurality of chemical injections can be utilized to facilitate paraffin buildup in one or more pipes in the disclosed treatment system 100. In one embodiment, fluid streams 23a, 23b are provided to an in-line accumulator bin (not shown) prior to being received in oil/water separators 253a, 253b, respectively, to allow additional time for the chemical reactions to take place. In other embodiments, fluid streams 23a, 23b are routed directly to at least one oil/water separator or other oil separation device, which is configured to separate the oil from the fluid stream. In some embodiments, each sump or unloading bay from the input station is coupled to a water/hydrocarbon fluids output line (such as streams 21a, 21b) such that a plurality of oil/water separators 253a, 253b is used. In other embodiments, one or more heat exchangers or heating devices may be utilized to help pre-treat the fluid for oil separation. In other embodiments, a plurality of chemical injections can be applied directly to de-sanding tanks 251a, 251b. A similar or different process and/or configuration can be utilized to recover oil from the second stream 21b as compared to the first stream 21a. For example, different injection fluids may be needed for the fluid exiting from a drill mud sump as opposed to the fluid exiting from a frac fluid sump or incoming trucks; likewise, a heat exchanger or other separate device may be used for one set of fluids but not used for another set of fluids.

In general, an oil/water separator is capable of treating oil and hydrocarbons through a separation and retention time process. The oil/water separator is configured such that, with sufficient time, water settles toward the bottom of the oil/water separator and hydrocarbons rise to the top of the tank based on differences in their specific gravity. This separation process is also encouraged due to the slow velocity of the inlet fluid. Oil and hydrocarbons, having a lower specific gravity than that of water, form an oil layer near the top of the oil/water separator and flows out of the top of the tank through oil outlet stream 25a, 25b into one or more recovery oil storage tanks 255, while the fluid layer near the bottom of the oil/water separator (consisting of mostly water) is routed via streams 27a, 27b to water pre-treatment system 130 for further removal of solids. Oil recovered in oil storage tank 255 can be sold, transported, or further purified as appropriate.

In one embodiment, each oil/water separator has a capacity of approximately 1,000 barrels. In some configurations, each oil/water separator may have its own oil storage tank, and in other configurations, a plurality of oil/water separators may share a common oil storage tank. While FIG. 2B shows a single oil/water separation tank for each incoming fluid stream, a plurality of separation tanks may be arranged in serial for each fluid line, such that one or more of the outputs from a first oil/water separation tank may be sent to a second oil/water separation tank for enhanced oil recovery. Other oil/water separation devices may be utilized besides this particular oil/water separation tank that fall within the scope of this invention, such as gun barrels, gravity separation devices, centrifuges, and gas flotation units. In other embodiments, a heat exchanger or heating apparatus is part of and/or coupled to the oil/water separator.

### Step III—Water Treatment

Referring back to FIG. 1, after oil has been recovered from oil and water separation system 120, hydraulic fracturing fluid (or other waste fluid that is being treated) that contains a high level of total suspended solids (TSS) within the fluid enters via stream 4 into water treatment system 130. One or more processes or treatment steps in water treatment system 130 are configured to remove unwanted solid particles and/or contaminants that precipitate via stream 12. The removal of these solids/precipitates to acceptable levels allows the hydraulic fracturing fluid to be classified as recycled frac water, which exits via stream 5 and can be held in a recycled water storage system 140 (such as a pond).

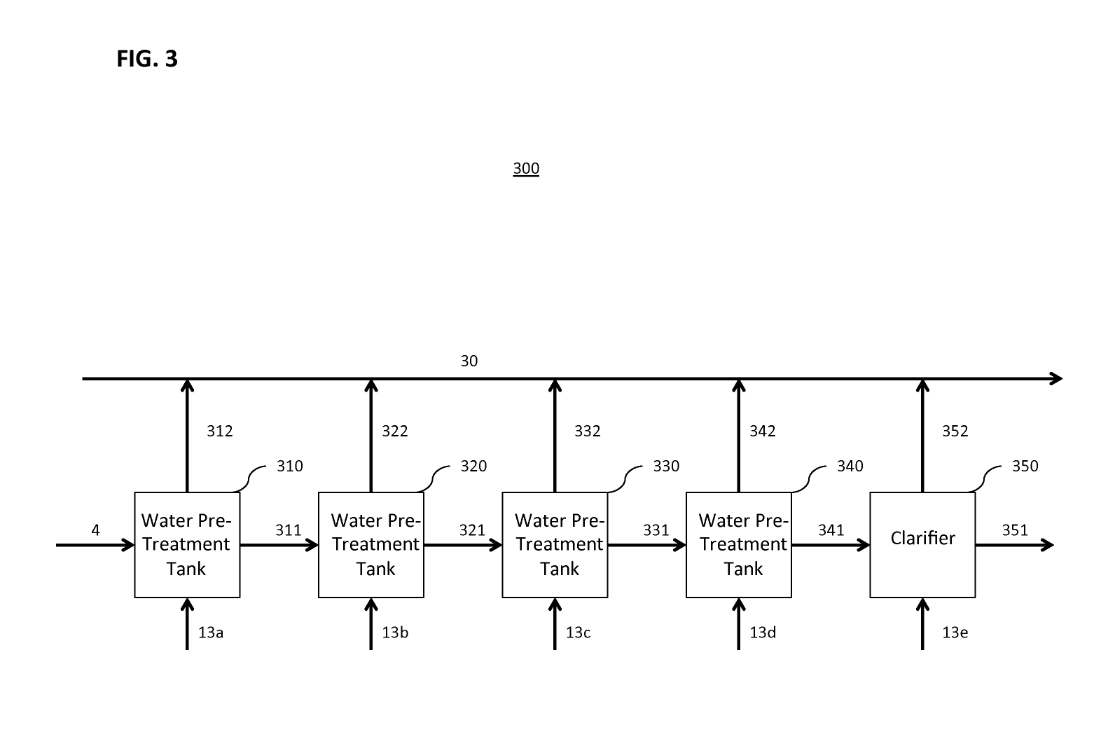

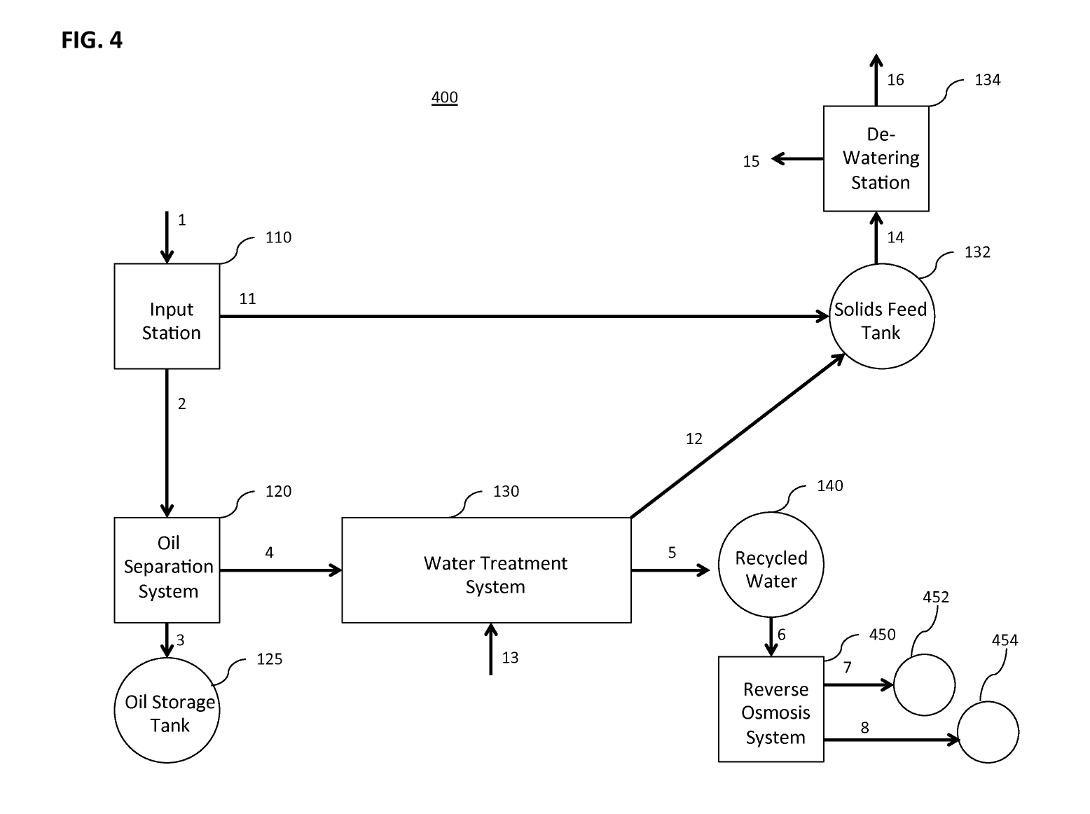

In one embodiment, as shown in FIG. 3, water treatment system 300 comprises a plurality of water pre-treatment tanks and a clarifying unit whereby one or more chemicals are injected via input stream(s) 13a, 13b, etc. In some embodiments, water treatment system 300 may comprise or be coupled to solids feed tank 132 and/or dewatering system 134 such that solids exiting the water treatment system via stream 12 (see FIG. 1) are routed for collection and further processing. In still other embodiments, water treatment system 300 may comprise or be coupled to a reverse osmosis (RO) unit 450 (see FIG. 4).

### Water Pre-Treatment Tanks

As shown in FIG. 3, in one embodiment, water treatment system 300 is comprised of multiple water pre-treatment tanks (e.g., four), each configured for chemical injections with inline mixers to facilitate unwanted solid particles/contaminants and precipitate removal. In one embodiment, each of the four pre-treatment tanks is configured as a train treatment process. In one embodiment, water pre-treatment tank 310 is configured to remove barium and radium from the fluid, water pre-treatment tank 320 is configured to adjust the pH in the fluid, water pre-treatment tank 330 is configured to reduce the level of TSS in the fluid, and water pre-treatment tank 340 is configured to further reduce the level of TSS in the fluid. In other embodiments, each water pre-treatment tank may be a container, sump, pond, pit, or other suitable storage unit that can hold and treat large quantities of fluid. More or less treatment tanks and steps may be utilized, and some wastewater fluids may not require all of the processes detailed in each of the water pre-treatment tanks. Further, one embodiment may incorporate a plurality of clarifier units following after each pre-treatment tank to further remove solids.

In the first step of the disclosed embodiment, barium and radium (trace amounts which are found in hydraulic fracturing fluids and other waste fluids) are removed from the incoming fluid stream. In one embodiment, water pre-treatment tank 310 is configured to remove barium and radium from fluid stream 4 (received from oil and water separation system 120) to an acceptable level such that the fluid can be classified as useable recycled frac water under the appropriate standards. In one embodiment, sodium sulfate and/or barium chloride may be injected into water pre-treatment tank 310 to remove barium or radium through a chemical reaction. In other embodiments, sodium sulfate and/or barium chloride may be injected into the fluid prior to entry into water pre-treatment tank 310 and the resulting admixture is sent to an inline static mixer prior to entry into the first pre-treatment tank. During this phase, barium sulfate will precipitate and if radium is present in the fluid, radium will co-precipitate with the barium sulfate. The addition of barium chloride is dependent on whether or not radium is present in the fluid. If radium is not present, barium chloride will not be necessary. Any resulting precipitates from these chemical reactions may be removed and collected in a solids feed tank via stream 312, similar to how solids are collected and stored from the sump stations of input station 110. Solids are primarily removed from the first pre-treatment tank by pumping the accumulated solids that have gravity settled along the bottom of the tank to the solids feed tank. In one embodiment, any precipitated radium and co-precipitates can be stored in a separate solids feed tank/container to prevent contamination of radium with the other solids removed. Removing these precipitates is important to prevent scaling downstream in the RO membrane filter (see FIG. 4) and in order to meet appropriate environmental standards allowable to recycle the hydraulic fracturing fluid for a fracturing process.

In the second step, treated water flows from the first water pre-treatment tank 310 to the second tank 320 via stream 311, which is configured to adjust the pH level of the fluid. In this flow path and/or tank, a caustic (e.g., sodium hydroxide) is injected into the fluid to adjust and raise the pH, and the resulting admixture is provided to an inline static mixer to increase the mixing of the components. At higher pH levels, certain precipitates are capable of forming and can therefore be separated from the water after an adequate retention time period. For example, both calcium and magnesium form solid precipitates at pH levels ranging from 8.5-10.0 as calcium hydroxide and magnesium hydroxide during this pH adjustment phase and can be removed via stream 322. Such precipitates can be removed in a variety of solid removal mechanisms as mentioned previously.

In the third step, treated water flows from the second pre-treatment tank 320 to the third tank 330 via line stream 321, where a cationic coagulant is injected to the feed water to accelerate the settling of any solids by increasing particle size and enhancing separation. After injection of a coagulant, the feed water flows through an inline static mixer to allow the fluid to mix sufficiently with the coagulant. In one embodiment, the coagulant is aluminum sulfate (alum), which reacts with particles within the fluid and results in positively charged ions, thereby causing the remaining solid particles to separate from the water more effectively, which can be removed via stream 332. In the fourth water pre-treatment step, water flows from the third pre-treatment tank 330 to the fourth tank 340 via stream 331, which allows any further solids to separate (via gravity settling, with or without chemical injections to aid in separation) within the liquid and be removed via stream 342.

Solids can be removed from one or more (preferably all) of the pre-treatment tanks by a variety of mechanisms via streams 312, 322, 332, 342, and 352 and sent to solids feed tank 132 via line 30 for further processing. In one embodiment, the further processing comprises pressurizing the fluid containing solids through a filter press to dewater and collect the removed solids. Depending on the fluid being treated, one or more of these steps may not be needed, or alternatively, other treating steps may be necessary. In one embodiment, fluid output 341 from the last pre-treatment step is re-circulated such that it is routed through the plurality of water pre-treatment tanks again for further treatment, which may result in increased water purification.

### Clarifier

As mentioned above, in one embodiment, water treatment system 300 may comprise or be coupled to clarifying unit 350. Clarifiers are well known in the art and may comprise many types of configurations and uses. In one embodiment, as shown in FIG. 3, treated water from the last pre-treatment tank 340 is provided via stream 341 to slant plate clarifier 350 (also known as a lamella plate clarifier). A slant plate clarifier is advantageous for industrial wastewater solids and frac water fluids because it has no moving parts and is designed to provide a low cost and efficient solids removal process for a wide range of waste and process liquids. In one embodiment, influent is fed into the top of clarifier 350 and flows under a baffle to the integral flash mixing tank where an anionic flocculating agent is added into the fluid. From a flocculation tank of clarifier 350, the fluid flows downward through the feed channel between two plate stacks to a sludge chamber at the bottom of the clarifier. The fluid velocity decreases in the sludge chamber, allowing large particles to drop out of suspension from the fluid. With time, the solids settle along the plate surfaces due to gravity, while the fluid continues moving upward through the plate stacks and into a discharge trough. Clean water exits clarifier 350 via stream 351 and may be sent to water storage tank 140. In one embodiment, an oxidation agent may be injected after the water has left the clarifier in order to prevent bacteria and microbes from contaminating the collected water 140. In another embodiment, water from clarifier 350 may flow through a filter in order to remove any remaining solid particles that may overflow from the clarifier. Treated water may then recirculate back through the system should further treatment be necessary.

In other embodiments, sludge from clarifier 350 may only be 1-2% solids content. However, it may be preferred that the solids content should be larger to pressurize through the filter press. Thus, the accumulated sludge in the clarifier may be periodically collected and sent to a sludge thickening unit (not shown), which may be located after the clarifier. By introducing the sludge from the clarifier with the sludge thickener, stored sludge can be increased in solids content, and may be compacted to approximately 5-10% solids content. This thickened sludge may be sent back to the clarifier where the sludge is collected and sent to the solids feed tank. In still other embodiments, each of the solid waste streams from the plurality of water pre-treatment tanks may be introduced with a sludge thickener for more effective solids processing.

As shown in FIG. 1, after passing through the clarifier and/or the last treatment step in water treatment system 130, the treated water is ready to be recycled/reused and may be stored in a storage pond or storage container 140 prior to transportation and/or use. In other embodiments, as shown in FIG. 4, the treated water may flow from storage pond or storage container 140 into a reverse osmosis system for further purification.

### Filter Press & Dewatering

As mentioned above, in one embodiment, as shown in FIG. 1, the water treatment system 130 may comprise or be coupled to a dewatering process and/or unit 134. In one embodiment, a solids feed tank 132 is configured to hold fluids that contain solids for subsequent treatment or disposal. Solids feed tank 132 may be coupled to de-watering station 134 via stream 14. Once the appropriate amount of solids is present in solids feed tank 132, the solids are pressurized through de-watering station 134, further separating the solids from any liquids. In one embodiment, the disclosed dewatering station is a conventional filter press configured to further separate the collected solids from any fluid, and in other embodiments a plurality of filter presses or dewatering centrifuges may be used. The filter press may comprise a plurality of filter cloths or membranes that are configured to absorb fluids associated with the solids. In one embodiment, the solid/fluid mixture is passed through the filter press via stream 14 at high pressures to facilitate fluid removal. The filter press may produce a dewatered sludge cake stream 15 with a solids content in the range of 30-60%. The dewatered solids/sludge cake can be collected in a storage bin or container and subsequently discarded or re-used for other purposes, such as road base or other land treatment applications (see FIG. 5). In one embodiment, fluids output stream 16 from filter press 134 may be re-circulated to water treatment system 130 for further processing, which may result in increased water purification.

### Reverse Osmosis

Referring now to FIG. 4, one embodiment of water treatment system 400 is illustrated that utilizes and/or is coupled to reverse osmosis (RO) system 450. FIG. 4 is substantially similar to the system described in FIG. 1 but for the addition of RO system 450. RO system 450 may be utilized to provide a higher level of purified water than is necessary for hydraulic fracturing fluids. In one embodiment, the RO system is utilized to obtain completion fluid and clean water for cement operations or irrigation applications. Treated water stream 5 from water treatment system 130 is sent to storage pond or container 140 containing treated water suitable for recycled hydraulic fracturing fluid and may be routed to RO system 450 for further purification via stream 6. In other embodiments, treated water is routed directly from water treatment system 130 to reverse osmosis system 450. In one embodiment, RO system 450 produces a plurality of water outputs 7 and 8, in which water output stream 7 is a permeate water stream (e.g., clean/treated water) and is output to permeate water pond or tank 452 and water output stream 8 is a concentrated water stream (e.g., water stream that is concentrated with salt and other contaminants) and is output to concentrate water pond or tank 454. In one embodiment, the treated water in permeate stream 7 may have less than 2000 parts per million (ppm) of Total Dissolved Solids (TDS), which is generally understood to be satisfactory for making concrete, and in some embodiments may be between 250-1000 ppm or less of TDS. Various publications exist that discuss the qualities and characteristics of water (including recycled/treated water) for cementing operations, including one publication entitled “Quality of Water for Making Concrete: A Review of Literature,” International Journal of Scientific and Research Publications, Volume 5, Issue 1, January 2015, Kucche et al., incorporated herein by reference. In general, water sources that are drinkable may also be used for irrigation and cementing operations, and in one embodiment the water in permeate stream 7 has properties approximately that of large city water supplies, which are publicly known/available. In other embodiments, fluid stream 5 that is intended for reuse as a hydraulic fracturing fluid need not pass through RO system 450 and is ready to be recycled/reused after exiting water treatment system 130.

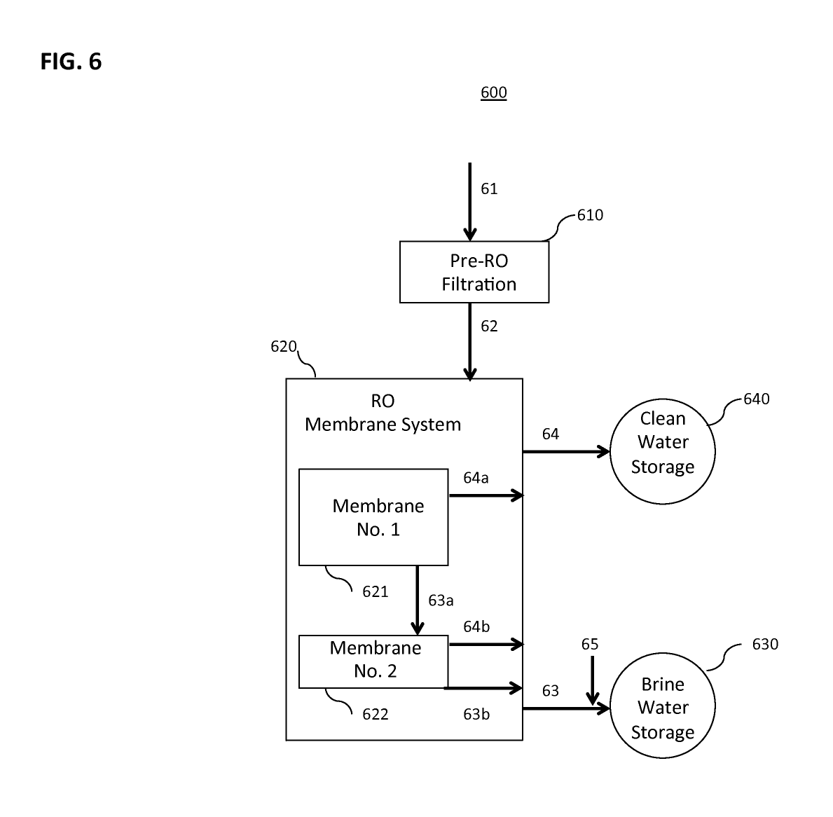

FIG. 6 shows one embodiment of an RO system. In one embodiment, RO system 600 comprises one or more pre-RO filters 610, RO membrane system 620, and a plurality of water storage tanks or storage pits 630, 640. In some embodiments, RO system 600 may be coupled to storage pond 140. Water routed to RO system 600 is first pressurized before passing through one or more pre-RO filters 610. The pre-RO filters are configured to prevent any remaining solid particles from potentially scaling and damaging RO membrane system 620. In one embodiment, RO membrane system 620 is comprised of a plurality of RO membrane filters 621, 622. In other embodiments, only one RO membrane filter is used. After passing through pre-RO filters 610, water is routed through RO membrane filter 621 via stream 62, which is configured to remove trace amounts of suspended solids through its very small pore sizes and high-pressure requirement. Water pressurized through RO membrane 621 produces a permeate stream 64a. Permeate stream 64a is clean, filtered water that passes through the RO membrane to clean water storage 640 and will not contain salt or other trace contaminants. Water in storage tank 640 can be used for a variety of operations that require clean water, such as irrigation applications and cementing operations. Water that does not pass through RO membrane 621 is concentrate stream 63a and includes the remaining contaminants and salts within the fluid. In one embodiment, concentrate stream 63a may flow through second RO membrane filter 622 (which may be smaller than first RO membrane filter 621) in which any remaining water that passes through RO membrane 622 flows through permeate stream 64b is collected in clean water storage tank 640 with permeate stream 64a. Concentrate stream 63b can then be refortified with potassium chloride (KCl) or another weighting agent via stream 65 prior to or during entry into brine water storage tank 630, which increases the specific gravity of the fluid such that it can be re-used as a completion fluid for oil and gas wells. If only RO membrane 621 is utilized, permeate stream 64a is output as permeate stream 64 into clean water storage tank 640 and concentrate stream 63a is output as stream 63 into brine water storage tank 630.

### Solids Treatment & Re-use

Referring now to FIG. 5, one embodiment of a water treatment system is coupled to a solids treatment system. In one embodiment, waste treatment system 500 comprises a water treatment system and a solids treatment system. FIG. 5 is substantially similar to the water treatment system described in FIG. 4 but for the addition of a solids treatment system subsequent to dewatering station 134 and the addition of desander 510 prior to oil separation system 120. In other embodiments, desander 510 (which may be substantially similar to desanding tanks 251a, 251b) may be part of and/or coupled to oil separation system 120, as shown in FIG. 2B. The solids treatment operation is designed to receive, treat, and recycle or dispose of non-hazardous, RCRA-exempt (Resource Conservation & Recovery Act) solid waste from exploration and production activities. As described, in one embodiment solid waste may be received from the water treatment facility and/or directly from incoming trucks. Generally, incoming waste/dewatered solids may be routed from a dewatering station 134 via path 15 and initially treated in one or more solids treatment cells (STC) 536, which may be a six-acre portion of land configured to hold and treat the incoming solid waste. Following this pre-treatment process, wastes may be transferred to one or more land treatment areas (LTA) 537 (which may be a large portion of land, such as greater than 50 acres, 100 acres, or 250 acres) via path 21 for final treatment and on-site disposal, or one or more solids storage cells 538 via path 22 for future re-use as road base make-up material or clean fill material.

FIG. 7 shows one embodiment of waste treatment facility 700 that comprises input station 710 configured to receive solid and fluid wastes from a remote oil and gas facility, water treatment system 720 configured to treat and recycle a wide variety of received waste fluids for beneficial re-use, and solids treatment system 730 configured to treat and recycle solids for beneficial re-use, whether received directly from an oil and gas facility or provided from water treatment system 720. Waste treatment facility 700 may be located at a remote location from an oil and gas facility and may include the necessary roads, pathways, and valves/pipeworks connecting the different components of facility 700. In one embodiment, waste treatment facility 700 is located on approximately 65 acres while 450 or more acres are used for beneficial re-use and land treatment application (such as via LTAs 736a, 736b). A primary purpose of the disclosed facility is to treat and beneficially re-use all incoming waste streams (whether solid or fluid) without disposal and/or injection into a deep well, which is how conventional treatment processes for the oil and gas industry typically handle fluids and other wastes. This is a significant improvement over existing technologies and processes, and the disclosed system performs the described water treatment steps by using a novel arrangement and use of standard off-the-shelf components. In one embodiment, all of the treated water is either re-used within treatment facility 700 or transported off site to be beneficially re-used in a wide variety of applications, including but not limited to hydraulic operations, irrigation applications, and cementing operations. In one embodiment, no water is wasted or disposed of and substantially all may be beneficially re-used.

Input station 710 is configured to receive solid and fluid wastes from a remote oil and gas facility whether by train, truck, or other shipping mechanism. Input station 710 may be substantially the same as input system 110, and may be coupled to and/or part of water treatment system 720 and/or solids treatment system 730. In one embodiment, input station 710 comprises a plurality of truck unloading bays 712 (such as six or more bays) which are configured to receive shipping trucks, transfer the fluids from the trucks, and clean and wash the trucks. Different bays can be configured to receive different types of fluids. Input station 710 also comprises drill mud sump 714 that holds drilling mud received from a shipping truck or train. Because drilling mud is typically treated differently through the water treatment system than the other fluids, it may need its own tank/sump (e.g., drilling mud may be collected together and dewatered in drill mud sump 714 before it is treated by oil separation system 722 and subsequent treatment steps, such as water treatment trains 725). Input station 710 is configured to deliver incoming wastes to both solids treatment system 730 and water treatment system 720 as appropriate. In some embodiments, the truck unloading bays may also function as truck loading bays, in which trucks (after being cleaned) can receive clean/treated water from water treatment system 720 and deliver the treated water to a remote location for beneficial re-use.

In one embodiment, water treatment system 720 is substantially similar to the water treatment systems disclosed in FIGS. 1, 4, and 5. Water treatment system 720 may be interconnected by a plurality of conduits to solids treatment system 730 and to the various components within water treatment system 720. Water treatment system 720 may comprise a plurality of 18,000 barrel storage tanks 724a, 724b that are configured to hold fluid wastes from input station 710 prior to treatment within water treatment system 720, oil separation system 722 (which may be substantially similar to water/oil separation system 120), a plurality of water treatment trains 725 (which may be substantially similar to the water treatment tanks in water treatment system 130), and de-watering system 726 (which may be substantially similar to de-watering station 134). Water treatment system 720 may also comprise a plurality of ponds or tanks to hold treated water/fluids during or after various treatments or processes within facility 700. In one embodiment, water treatment system 720 comprises recycled water retention pond 727 (which may be substantially similar to recycled frac water tank 140) that may be configured to hold approximately 250,000 barrels of treated fluid after being processed by one or more of water treatment trains 725. In some embodiments, such as when reverse osmosis system 723 is utilized, water treatment system 720 may also include permeate water pond 728 and concentrate water pond 729, which are each configured to hold approximately 35,000 barrels of fluid.

In operation, wastewater from input station 710 (whether via truck unloading bays 712 or drill mud sump 714) is routed to oil separation system 722. Incoming fluid wastes (as well as the fluid after being treated) may be analyzed for total petroleum hydrocarbons and other constituencies and parameters, such as pH, turbidity, total iron, barium, sulfate, boron, and bacteria, which helps determines the specific water treatment steps performed (and concentrations thereof) within the plurality of water treatment trains 725. These measurements may be performed automatically or manually. Various solids removal steps may be performed (such as through de-sanding units 251 or shakers/filters, not shown in FIG. 7) during or prior to routing the fluid through oil separation system 722, including during cleaning of trucks at input station 710. Any solids initially removed may be transferred to de-watering system 726 or solids treatment system 730. Oil separation system 722 removes substantially all of the oil present in the incoming fluid streams and outputs the oil to one or more oil tanks (not shown) and the remaining waste fluid to a first train of the plurality of water treatment trains 725. In one embodiment, oil separation system 722 may comprise a plurality of de-sanding units and/or be coupled to one or more de-sanding units, such that any fluids are first routed through the de-sanding units prior to removal of oil. One or more water treatment steps are performed within water treatment trains 725 to remove any solids or contaminants in the fluid, which are routed to de-watering system 726. The treated/clean water is output to recycled water retention pond 727 and the solids waste stream (which may be partially solid and partially water) is routed to de-watering system 726. In one embodiment, the target treatment range for the treated water has a pH between 7.5-8.5, turbidity between 0.0-2.0 NTU, iron between 0.2-1.0 mg/L, barium between 10-50 mg/L, sulfate between 25-100 mg/L, boron between 30-50 mg/L, and bacteria between 2,400-27,500 ME/mL. In another embodiment, the target treatment level for the treated water has a pH of about 8.3, turbidity of about 1.0 NTU, iron of about 0.6 mg/L, barium of about 30 mg/L, sulfate of about 63 mg/L, boron of about 40 mg/L, and bacteria of about 15,000 ME/mL. In one embodiment, this target treatment level is met for the treated fluid to be classified and/or used as recycled fracturing fluid.

De-watering system 726 is configured to remove some of the water present in the solids waste stream and to route the de-watered solids stream to solids treatment system 730 and the water stream to one or more portions of waste treatment facility 700, and in some embodiments may re-route the water to the beginning of the water treatment trains 725 for further processing. In some embodiments, water may need to be further purified (such as for cementing operations, irrigation applications, and/or other highly purified water applications), and water from the recycled water retention pond 727 and/or water from water treatment trains 725 is further processed in one or more reverse osmosis systems 723 (which may be substantially similar to RO system 450). Reverse osmosis system 723 produces a concentrated water stream that is routed to concentrate water pond 729 and a permeate water stream that is routed to permeate water pond 728. The water in recycled water retention pond 727, permeate water pond 728, and concentrate water pond 729 may be transported to a remote location for beneficial re-use (such as for hydraulic fracturing operations, cementing applications, irrigation use, etc.), or be routed to other portions of treatment facility 700 that require water, such as solids treatment system 730.

In one embodiment, solids treatment system 730 is configured to receive, store, handle, treat, and recycle a wide variety of nonhazardous solid wastes from an oil and gas operation facility. Such wastes may include (but not be limited to) washout pit solids, produced formation sand, solids from saltwater storage tanks, contaminated soil from spills of crude oil and condensate and saltwater, production tank bottoms, non-hazardous solids from natural gas plant processing and other production facilities, clay liners from reserve and washout pits, water-based drilling fluids and cuttings, and oil-based drilling fluids and cuttings. Thus, while characterized as solid wastes, such wastes may include a substantially fluid portion with solids generally present in the fluid. Further, solids treatment system 730 is configured to receive and treat all solids produced and/or recovered from water treatment system 720. Prior to treatment, incoming fluid/solid wastes may be analyzed for various constituents of concern (COCs) and waste parameters, such as total petroleum hydrocarbons, benzene, RCRA 8 metals, pH, chlorides, electrical conductivity, sodium adsorption ratio, exchange sodium percentage, cation exchange capacity, ignitability, and total organic halides. Additional analysis may be required for certain wastes and additional COCs may be analyzed as appropriate.

In one embodiment, solids treatment system 730 is configured to process approximately 950,000 barrels of solid waste per year (or approximately 200,000 cubic yards of untreated solid waste per year). More particularly, solids treatment system 730 may be configured to produce approximately 60,000 cubic yards of clean fill material per year, approximately 60,000 cubic yards of road base make-up material per year, and approximately 80,000 cubic yards of material for land treatment areas per year. The disclosed system is scalable, and can easily be adjusted to increase or decrease the amount of solid wastes that the facility can receive and treat. Solids treatment system 730 may comprise a plurality of Solids Treatment Cells (STCs) 732, a plurality of Solids Storage Cells (SSCs) 734, and one or more Land Treatment Areas (LTAs) 736. Each of these is discussed in more detail below.

In one embodiment, solids treatment system 730 comprises a plurality of Solid Treatment Cells (STC) 732a, 732b, etc. for specific treatment steps within the STC. Each STC is a container, tank, or specific unit or delineated area within a pond or other marked surface area. The size of each STC may vary based upon the expected volume of treated material, and in one embodiment may be between one to six acre portions of land configured to hold and treat the incoming solid waste. Each STC 732a, 732b may be configured to reduce concentrations of constituents of concern (COCs) to acceptable levels prior to transfer to other portions of the solids treatment system, such as LTA 736a, 736b and/or SSC 734a, 734b, 734c. In one embodiment, each of the plurality of STCs 732a, 732b uses chemical alteration, physical adsorption, biodegradation, and/or leaching processes to reduce COC concentrations to levels acceptable for further treatment or beneficial re-use. Solid waste received at each STC may be separated into two separate treatment areas: STC-Hydrocarbons (STC-H) and STC-Salinity (STC-S). These treatment areas may be further partitioned based on COC concentrations for Total Petroleum Hydrocarbons (TPH) and salinity (EC) (or other factors) determined from analysis of incoming solid waste. For example, in one embodiment, the partitions for the STC-H cells may include a first partition for high hydrocarbon levels and low salinity levels (e.g., TPH>10,000 mg/kg and EC<8 mmhos/cm) and a second partition for high hydrocarbon levels and moderate salinity levels (e.g., TPH>10,000 mg/kg and EC between 8-18 mmhos/cm). As another example, the partitions for the STC-S cells may include a first partition for moderate levels of salinity (e.g., EC between 8-18 mmhos/cm), a second partition for high levels of salinity (e.g., EC between 18-36 mmhos/cm), and a third partition for very high levels of salinity (e.g., EC>36 mmhos/cm). Thus, in one embodiment, solids treatment system 730 may comprise approximately five STC partitions 732a-732e, and each STC may process approximately between 5,000 to 100,000 cubic yards annually for a total capacity of approximately 150,000 cubic yards or more per year.

In one embodiment, solids treatment system 730 comprises a plurality of Solids Storage Cells (SSCs) for temporary storage of the solids before re-use, and may be separated into different storage cells for the intended application. For example, Solids Storage Cell No. 1 (SSC1) 734a may be used to stage material from one of the plurality of STCs destined for application in one of LTAs 736a, 736b, Solids Storage Cell No. 2 (SSC2) 734b may be used to store road base make-up material for future beneficial re-use, and Solids Storage Cell No. 3 (SSC3) 734c may be used to store clean fill material for future beneficial re-use. In one embodiment, each of the SSCs may be in the form of a storage tank, container, or pond with a capacity of about 3,000 cubic yards. Depending on the SSC, the contained material may be transported offsite to a permitted recycling facility for subsequent processing (such as the road base material found in SSC 734b) or be purchased by local operators and transported off-site for use as excavation fill material or firewall/earthen berm construction for secondary containment at production facilities (such as the clean fill material found in SSC 734c).

In one embodiment, solids treatment system 730 comprises a plurality of LTAs 736a, 736b, such as eleven LTA sections. The land treatment areas (LTAs) are configured to render oil and gas exploration and production fluid and solid wastes harmless through soil incorporation. The disclosed land treatment method may use dilution, chemical alteration, physical adsorption, and/or biodegradation processes to reduce COCs to levels consistent with intended land use and concentrations protective of groundwater. This technique provides both treatment and final disposal of salts, petroleum hydrocarbons, and metals. Each LTA section may be constructed to retain a 25-year, 24-hour rainfall event. In one embodiment, each LTA is segregated to maintain an average slope of approximately 2% and detain the indicated storm event. The size of the sections and earthen berm heights vary due to differences in topography and natural damage, but may vary between approximately 20 acres (or less) to 45 acres (or more).

Each LTA 736a, 736b may have a plurality of subsurface zones for waste incorporation and verification soil sampling. For example, each LTA may have a first (upper) treatment zone between 0 to 16 inches below grade, a second (lower) treatment zone between 17 to 33 inches below grade, and a third (compliance monitoring) zone between 34 to 48 inches below grade. The LTA waste application rates and closure limits may be established for each LTA section prior to the application of waste based on site-specific soil characterization data from each section. The LTA is intended to address COCs associated with salinity, sodicity, and metals through incorporation with native soil to a depth of 18 inches below ground surface. Hydrocarbon constituents are addressed through pre-treatment in STC 732a, 732b, etc. Therefore, waste can be applied below the 12-inch depth limit for land treatment that may be conventionally used. In one embodiment, the plurality of LTA sections 736a, 736b may process approximately 80,000 cubic yards annually.

For solid wastes to be used as land treatment applications, the solid waste is first characterized to determine the makeup of the material, which may be done in the relevant STC. For a given volume of waste, a volume of native soil is calculated to reduce the concentration of each COC to reach acceptable limits within the upper 18 inches of native soil. The COC that requires the most native soil acts as the limiting COC, and in some embodiments the limiting COC may need to be specifically treated in the STC to make it more in line with the other COCs for the approximate volume of native soil needed. Once the amount of native soil has been calculated, the waste may be applied to the native soil by a variety of mechanisms, including incorporating 50% of the material into the Upper and Lower Treatment zones (e.g., 0 to 17 inches and 17 to 33 inches, respectively). Over a period of weeks and/or months, the treated soil (e.g., the combined native soil with incorporated solid wastes) is monitored to verify that acceptable treatment levels have been met. Once verified, any earthen berms are removed, treatment areas are leveled to approximate natural surface grade, and grass seed mix (with fertilizer) may be applied.

### Water Treatment and Solids Treatment Processes

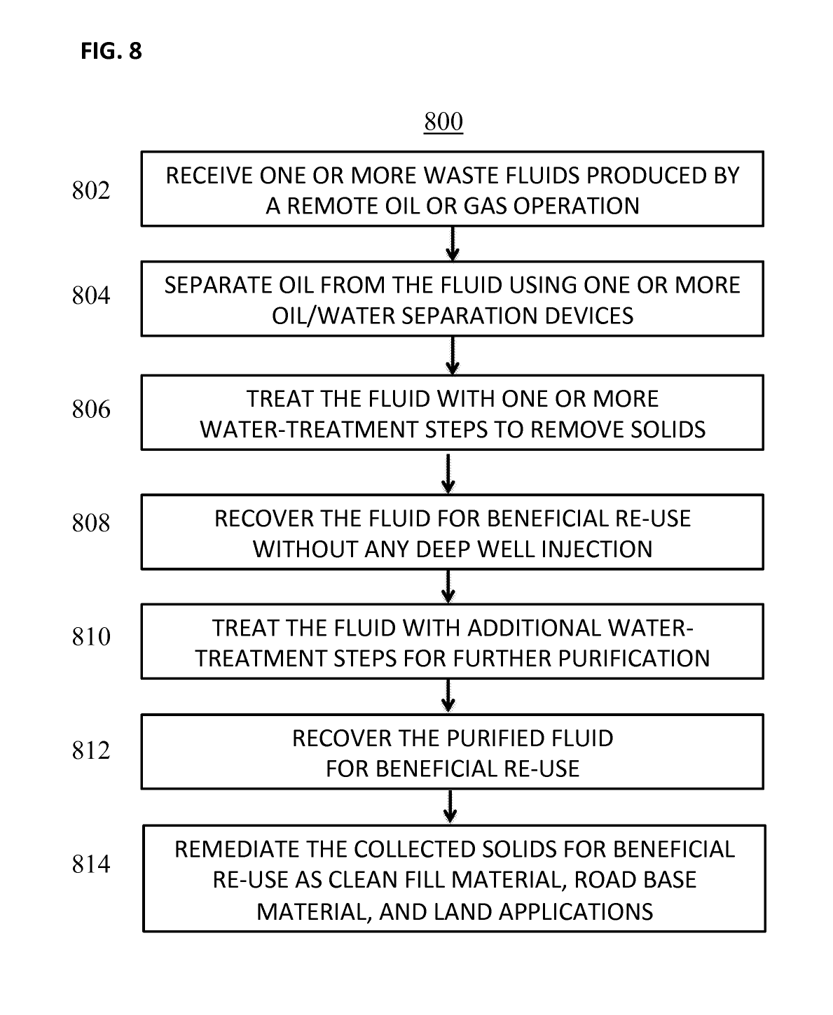

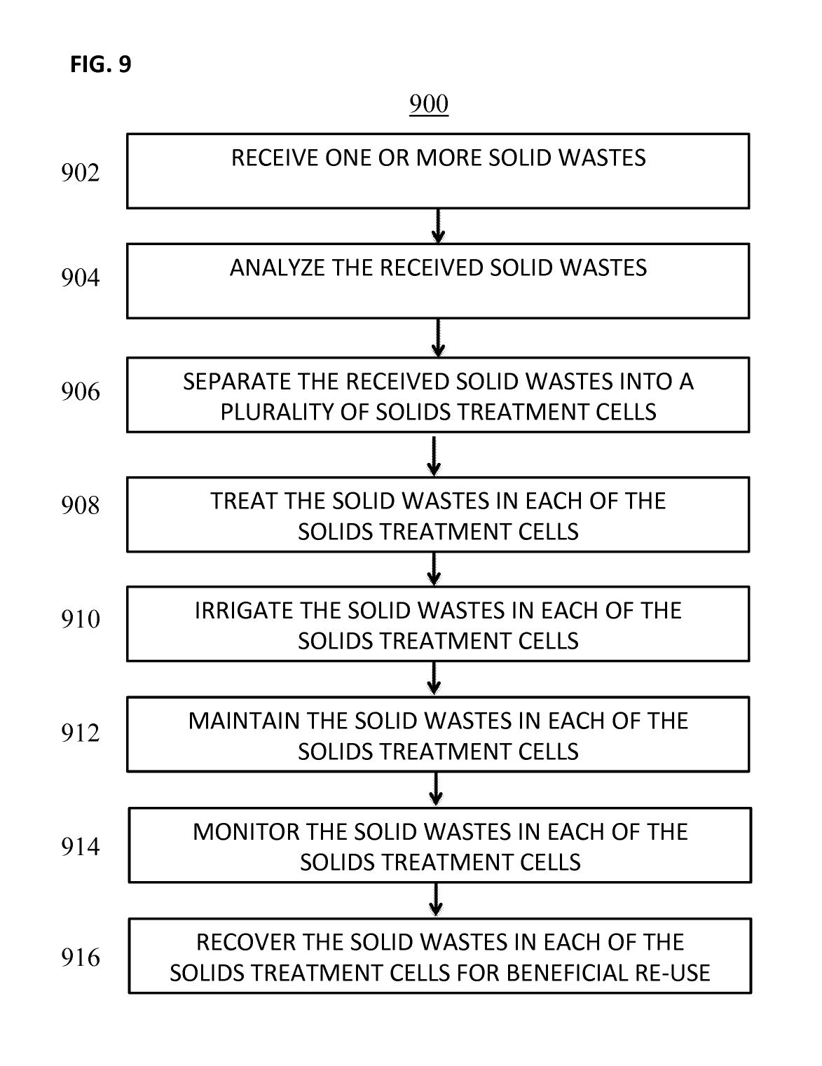

FIG. 8 shows one embodiment of water treatment process 800 according to the disclosed embodiment. Water treatment method 800 first comprises receiving wastewater (such as hydraulic fracturing fluid) at a facility for processing and/or treatment (such as water treatment system 720), as shown in step 802. The facility may be remote to the source of wastewater or be on the same site as the oil and gas production well. Transportation to the treatment facility may be performed by train, trucks, or pipelines. Solids may or may not be initially screened from the incoming waste fluid. Second, one or more streams of the incoming waste fluid (which contains small amounts of oil/hydrocarbons) may be processed by one or more oil water separation devices to collect and/or separate the oil from the water mixture, as shown in step 804. In one embodiment, a plurality of de-sanding tanks and oil/water separation tanks are used. Third, the fluid is treated by one or more water treatment processes to remove solids and other constituents from the fluid mixture, as shown in step 806. In one embodiment, a first water-treatment process comprises precipitating barium and/or radium from the water with sodium sulfate, a second water-treatment process comprises adjusting the pH with sodium hydroxide, and a third water-treatment process comprises providing a cationic coagulant to the mixture for enhanced particle destabilization. More or less water treatment processes may be utilized. For example, the water may be treated by an anionic flocculating and/or clarification agent/process to further remove solids. In some embodiments, solids are removed from each water-treatment process by a filter or other solids removal device (such as gravity settling) and provided to a solids storage container. In other embodiments, the solids storage container may be coupled to a dewatering unit, such as a dewatering centrifuge or filter press that removes some or substantially all of the water in the solids fluid stream. In still other embodiments, the solids are routed to a solids treatment facility and/or process for further treatment to the solids. Fourth, as shown in step 808, the treated water may be recovered in a water storage system (such as a pond or one or more storage containers, ponds, or tanks) and subsequently transported or used in well completion operations, such as for re-used hydraulic fracturing operations. The treatment method treats and recovers the fluid without any deep well injection, as is required in conventional oil and gas wastewater processing systems. In some embodiments, the treated water may need to be further purified for some operations or uses, such as cementing operations, irrigation applications, and completion fluids. In these embodiments, the treated water may be routed to an additional water-treatment system or enhanced purification device, such as a reverse osmosis system, as shown in step 810. Next, as shown in step 812, water exiting the reverse osmosis system may be recovered in one or more water storage tanks for beneficial re-use of the purified water. In one embodiment, the reverse osmosis system produces two streams of water, a permeate stream and a concentrate stream, and each stream of water is routed to a separate water storage tank for appropriate use. One of ordinary skill in the art may vary the components described herein for a variety of applications and configurations. For example, in addition to or in lieu of the reverse osmosis system, an ion exchange treatment or gel membrane filtration system can be utilized for enhanced water purification. Lastly, as shown in step 814, solid materials that have been dewatered from the filter press may be recovered for beneficial re-use as clean fill material, road base material, and on-site land applications. The solid materials may be treated at a solids treatment facility (that may be coupled to the disclosed water treatment facility, such as solids treatment system 730) and/or one or more solids treatment processes, which is further described in relation to FIG. 9.

FIG. 9 shows one embodiment of solids treatment process 900 according to the disclosed embodiment. First, as shown in block 902, the solids treatment process 900 includes receiving solid wastes at a solids treatment facility (such as facility 730) that are to be treated. In one embodiment the solid wastes may be received through input station 710 or output by water treatment system 720. Second, the process includes analyzing and/or characterizing the incoming solid waste to determine the various constituencies and parameters of the waste, as shown in block 904. Third, as shown in block 906, the solids treatment process includes partitioning and/or separating the wastes into a plurality of Solids Treatment Cells (such as STCs 732a, 732b, etc.) based upon a variety of factors, including TPH and/or salinity concentrations. Fourth, the partitioned wastes are treated according to various procedures depending on the material located within the STC, as shown in block 908. For example, calcium (such as calcium nitrate or calcium sulfate) and/or fertilizer (such as a standard 13-13-13 fertilizer) made by added to each of the STCs by mechanically incorporating (e.g., spreading, lifting, tilling, etc.) the amendments into the waste at a depth of 24 inches or more. Fifth, the solids treatment process 900 further includes irrigating the partitioned wastes on a daily basis in the amount of between 50,000 to 400,000 gallons of water per month, as shown in block 910. For efficiency purposes, such water may be supplied from the treated water produced from water treatment system 720. Sixth, as shown in block 912, the partitioned wastes may require additional maintenance during the treatment steps, such as mixing the waste weekly to promote aeration and biodegradation and/or tilling the waste weekly/monthly to promote water infiltration. Seventh, the solids treatment process 900 further includes monitoring each STC for various parameters, as shown in block 914. The monitoring process may include separating each STC into equal segments (such as six or more segments) and collecting (and testing) samples at various depths within each segment, such as 0 to 12 inches below grade, 12-24 inches below grade, and 24-42 inches below grade. The monitoring process can be done on a weekly or monthly basis during treatment and after treatment. Lastly, the solids treatment process 900 further includes recovering the solid wastes in one or more of the STCs after the constituent of concern (COC) concentrations reach the target treatment levels for each of the COCs, as shown in block 916. Once the COC concentrations have been met, the solid waste within the solids treatment cell may be removed and transferred to the appropriate solids treatment operation and/or area within the solids treatment facility. For example, solid wastes to be beneficially re-used as clean fill material may be transferred to Solids Storage Cell (SSC) 734a, solid wastes to be used as road base material may be transferred to SSC 734b, and solid wastes to be used for on-site land applications may be transferred to SSC 734c. In some embodiments, various land treatment applications may be used on site for a portion of the treated solid wastes. More or less of the illustrated steps may be used based on the solid waste treated and the intended re-use application.

In one embodiment, the disclosed processes and facility may be semi-automated in order to control the described processes, increase safety, promote efficiency, and prevent spillage or overflow at each treatment method. Level controls and transmitters may be used to prevent overflows in the sumps, tanks, and other containment equipment. In other embodiments, the disclosed system may be controlled by mass balance that uses measuring of flow streams in and out of each component and/or process. In order to control the flow streams, variable frequency drive motors may be implemented at various stations utilizing one or more pumps. In one embodiment, injected chemicals may be controlled by the flow streams and the rate of caustic injection may be dependent on the pH level. In other embodiments, a plurality of sensors are utilized that can monitor one or more conditions of the system and/or process for local and/or remote monitoring. In one embodiment, one or more aspects of the process can be remotely managed via a network or the Internet. The disclosed process may operate continuously or in batches. For simplicity, the disclosed figures do not show the valves, pumps, pipes, and joining pipe components necessary to combine the flows to and from the plurality of components, but such pipeworks are within the knowledge of one of ordinary skill in the art.

Although the invention(s) is/are described herein with reference to specific embodiments, various modifications and changes can be made without departing from the concept, spirit, and scope of the present invention(s). For example, the disclosed water treatment and solids treatment system is fully saleable, such that smaller and larger amounts of waste can be processed depending on the expected volume of waste. Such a scalable system is economical and cost effective for a variety of waste treatment applications. Further, because the makeup of the waste water fluid varies, both on the type of fluid, the well, and even over time, the incoming fluid composition needs to be constantly monitored to determine the most appropriate processes to effectively treat the fluid. In some instances, the composition of the fluid may need to be initially adjusted (such as at the input station) prior to processing by the water treatment facility. In addition, modifications may be made to the disclosed system and components/processes may be eliminated or substituted for the components/processes described herein where the same or similar results would be achieved. All such similar substitutes and modifications apparent to those skilled in the art are deemed to be within the spirit, scope, and concept of the invention. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of the disclosed invention. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages may be added or existing structural components and/or processing stages may be removed or modified. Further, one or more of the acts depicted herein may be carried out in one or more separate acts and/or phases.

Other embodiments of the invention will be apparent to those skilled in the art from consideration of the specification and practice of the invention disclosed herein. It is intended that the specification and examples be considered as exemplary only, with a true scope and spirit of the invention being indicated by the present claims as follows.

What is claimed is:

1. A method of treating used fluids from an oil or gas operation, comprising:
receiving one or more used fluids at an input station, wherein the fluid comprises water, oil, and a plurality of contaminants;
recovering a portion of the oil from the fluid;
treating the fluid with a plurality of water-treatment steps to remove the plurality of contaminants substantially from the fluid; and
recovering the treated fluid for beneficial re-use.

2. The method of claim 1, wherein the method comprises recovering the treated fluid without any deep well injection of the fluid.

3. The method of claim 1, wherein the fluid may be any fluid produced from an oil or gas exploration or production operation.

4. The method of claim 1, wherein the recovering step comprises using one or more oil/water separation devices.

5. The method of claim 1, wherein the treating step comprises precipitating barium or radium from the fluid with sodium sulfate.

6. The method of claim 5, wherein the treating step comprises adjusting the pH of the fluid with sodium hydroxide.

7. The method of claim 6, wherein the treating step comprises providing a coagulant to the fluid for particle destabilization.

8. The method of claim 7, wherein the treating step comprises a clarification step.

9. The method of claim 1, wherein the treating step comprises treating the fluid to a level acceptable for recycled fracturing water.

10. The method of claim 1, further comprising purifying the treated fluid by using a reverse osmosis system.

11. The method of claim 1, further comprising recovering a plurality of solids from the treated fluid in a solids dewatering process.

12. The method of claim 11, further comprising treating the plurality of recovered solids for beneficial re-use.

13. The method of claim 12, wherein a first portion of the solids is treated for re-use as a clean fill material, a second portion of the solids is treated for re-use as a road base material, and a third portion of the solids is treated for re-use as a material for land application.

14. The method of claim 11, further comprising treating the plurality of recovered solids for beneficial re-use by separating the solids into a plurality of solids treatment cells, treating the solids in each of the solids treatment cells, and recovering the solids in each of the solids treatment cells.

15. A system for treating wastewater from oil and gas operations, comprising
one or more input stations configured to receive wastewater, wherein the waste water comprises water, oil, and a plurality of solids;
one or more oil separation systems configured to separate the oil from the water;
one or more water treatment systems configured to remove the plurality of solids from the wastewater to produce useable recycled wastewater; and
one or more dewatering systems configured to recover the removed solids.

16. The system of claim 15, wherein the recycled wastewater is produced without any deep well injection of wastes.

17. The system of claim 15, further comprising one or more de-sanding units configured to separate a portion of the solids from the wastewater prior to entry of the wastewater into the one or more oil separation systems.

18. The system of claim 15, further comprising a solids treatment system configured to treat the recovered solids for beneficial re-use, wherein the solids treatment system comprises a plurality of solids treatment cells and a plurality of solids storage cells.

19. The system of claim 18, wherein a first portion of the solids is treated for re-use as a clean fill material, a second portion of the solids is treated for re-use as a road base material, and a third portion of the solids is treated for re-use as a material for land application.

20. The system of claim 15, wherein the one or more input stations comprises a plurality of unloading bays configured to receive fluids transported by trucks or containers.

21. The system of claim 15, wherein the plurality of water treatment systems comprises a first water treatment tank configured to remove substantially all of the barium and radium from the fluid, a second water treatment tank configured to adjust the pH level of the fluid, and a third water treatment tank configured to reduce the level of TSS in the fluid.

22. The system of claim 21, wherein the plurality of water treatment systems comprises a clarifying unit.

23. The system of claim 15, wherein the one or more dewatering systems comprises a filter press.

24. The system of claim 15, further comprising a reverse osmosis system.

25. The system of claim 15, wherein the system is a mobile system configured to be transported to a remote facility for treatment of wastewater from the remote facility.

26. A scalable waste treatment system for treating waste produced from oil and gas operations, comprising
an input station configured to receive fluid wastes and solid wastes from a remote location;
a water treatment system configured to treat the received fluids to produce treated water for beneficial re-use, comprising one or more desanding systems configured to remove a first plurality of solids from the fluid, one or more oil/water separators configured to remove substantially all of any oil from the fluid, and one or more water treatment systems configured to remove a second plurality of solids from the fluid; and
a solids treatment system configured to receive solids from the water treatment system and treat the solids for beneficial re-use, comprising a plurality of solids treatment cells, wherein a first portion of the received solids is provided to a first solids treatment cell and a second portion of the received solids is provided to a second solids treatment cell.

27. The system of claim 26, wherein the treated fluid is acceptable for beneficial re-use as a fluid selected from the group consisting of irrigation water, completions fluid, and recycled fracturing fluid.

28. The system of claim 26, wherein a first portion of the solids is treated for re-use as a clean fill material, a second portion of the solids is treated for re-use as a road base material, and a third portion of the solids is treated for re-use as a material for land application.

29. The system of claim 26, wherein the input station is coupled to the waste treatment system and the solids treatment system and is configured to deliver fluids to the waste treatment system and solids to the solids treatment system.
